(19) United States
(12) Patent Application Publication
(10) Pub. No.: US 2025/0310979 A1
(43) Pub. Date: Oct. 2, 2025

(54) INFORMATION TRANSMISSION METHOD AND APPARATUS AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/867,161

(22) PCT Filed: May 23, 2022
(86) PCT No.: PCT/CN2022/094546

§ 371 Date: Nov. 19, 2024

(51) Int. Cl. H04W 72/51; H04W 72/044; H04W 72/231; H04W 88/06

(52) U.S. Cl. CPC H04W 72/51; H04W 72/044; H04W 72/231; H04W 88/06

(57) ABSTRACT

Information transmission methods and apparatuses, and storage mediums are provided. The information transmission method includes: sending configuration information to one or more unmanned aerial vehicles within a coverage range of the base station, where the configuration information is to configure one or more communication standards for the one or more unmanned aerial vehicles to broadcast identity information.

### CROSS-REFERENCE TO RELATED APPLICATIONS

The present disclosure is a U.S. national phase of PCT Application No. PCT/CN2022/094546 filed on May 23, 2022, the content of which is hereby incorporated by reference in its entirety.

### TECHNICAL FIELD

The present disclosure relates to a field of communication, and in particular, to information transmission methods and apparatuses and storage mediums.

### BACKGROUND

An unmanned-driven aerial vehicle is referred to as an unmanned aerial vehicle (UAV) for short and is an unmanned aircraft that is manipulated by a radio remote control device and a self-contained program control apparatus. The unmanned aerial vehicle is actually a general term for unmanned aircrafts, and may include from a technical perspective: an unmanned fixed-wing aircraft, an unmanned vertical take-off and landing aircraft, an unmanned airship, an unmanned helicopter, an unmanned multi-rotor aircraft, an unmanned umbrella wing aircraft, etc.

With rapid development of the unmanned aerial vehicle technologies, reduction of cost, and improvement of functions, unmanned aerial vehicles are increasingly applied to ordinary consumers. The application of the unmanned aerial vehicles in industries is a true necessity for unmanned aerial vehicles. At present, the application of the unmanned aerial vehicles in fields, such as aerial photography, agriculture, plant protection, micro self-shooting, express transportation, disaster rescue, wild animal observation, infectious disease monitoring, surveying and mapping, news reporting, electric power inspection, disaster relief, film and television shooting, creating romance, etc., has greatly expanded the use of the unmanned aerial vehicles. Various countries are actively expanding industry applications and developing the unmanned aerial vehicle technologies.

In order to further expand an application range of the unmanned aerial vehicle, the 3rd generation partnership project (3GPP) has approved an enhanced support for unmanned aerial vehicles item. It is intended to study and standardize how cellular networks can provide the unmanned aerial vehicles with services meeting requirements.

The current unmanned aerial vehicle mainly uses a wireless fidelity (WIFI) chip and WIFI based protocol, to perform direct connection with a controller to control and transmit data. However, the WIFI uses an unlicensed frequency band, which on one hand may result in channel occupancy, and on the other hand may result in relatively large interference and a limited coverage range. Cellular network communication is based on a licensed frequency band, so data transmission is guaranteed, and continuous coverage may be achieved. Therefore, more and more unmanned aerial vehicles in the cellular networks communicate in a dual-mode form, a cellular network communication standard and a WIFI communication standard.

### SUMMARY

Embodiments of the present disclosure provide information transmission methods and apparatuses, and storage mediums.

According to a first aspect of embodiments of the present disclosure, an information transmission method is provided. The method is performed by a base station and includes: sending configuration information to one or more unmanned aerial vehicles within a coverage range of the base station, where the configuration information is to configure one or more communication standards for the one or more unmanned aerial vehicles to broadcast identity information.

According to a second aspect of embodiments of the present disclosure, an information transmission method is provided. The method is performed by an unmanned aerial vehicle and includes: receiving configuration information sent by a base station, where the unmanned aerial vehicle is within a coverage range of the base station, and the configuration information is to configure a communication standard for the unmanned aerial vehicle to broadcast identity information; determining, based on the configuration information, a target communication standard for the unmanned aerial vehicle to broadcast the identity information; and broadcasting the identity information based on the target communication standard.

According to a third aspect of embodiments of the present disclosure, a computer readable storage medium is provided. The computer readable storage medium stores a computer program, and the computer program is configured to perform any one information transmission method in the side of the base station.

According to a fourth aspect of embodiments of the present disclosure, a computer readable storage medium is provided. The computer readable storage medium stores a computer program, and the computer program is configured to perform any one information transmission method in the side of the unmanned aerial vehicle.

According to a fifth aspect of embodiments of the present disclosure, an information transmission apparatus is provided. The apparatus includes: a processor; and a memory configured to store instructions executable by the processor; where the processor is configured to perform any one information transmission method in the side of the base station.

According to a sixth aspect of embodiments of the present disclosure, an information transmission apparatus is provided. The apparatus includes: a processor; and a memory configured to store instructions executable by the processor; where the processor is configured to perform any one information transmission method in the side of the unmanned aerial vehicle.

It should be understood that the above general description and the detailed description in the following text are only exemplary and explanatory, and cannot limit the present disclosure.

### BRIEF DESCRIPTION OF DRAWINGS

The accompanying drawings herein are incorporated into the specification and form a part of this specification, show embodiments conforming to the present disclosure and are used together with the specification to explain principles of the present disclosure.

FIG. 1 is a schematic flowchart of an information transmission method shown according to an exemplary embodiment.

FIG. 2 is a schematic flowchart of another information transmission method shown according to an exemplary embodiment.

FIG. 3 is a schematic flowchart of another information transmission method shown according to an exemplary embodiment.

FIG. 4 is a schematic flowchart of another information transmission method shown according to an exemplary embodiment.

FIG. 5 is a schematic flowchart of another information transmission method shown according to an exemplary embodiment.

FIG. 6 is a schematic flowchart of another information transmission method shown according to an exemplary embodiment.

FIG. 7 is a schematic flowchart of another information transmission method shown according to an exemplary embodiment.

FIG. 8 is a schematic flowchart of another information transmission method shown according to an exemplary embodiment.

FIG. 9 is a schematic flowchart of another information transmission method shown according to an exemplary embodiment.

FIG. 10 is a schematic flowchart of another information transmission method shown according to an exemplary embodiment.

FIG. 11 is a schematic flowchart of another information transmission method shown according to an exemplary embodiment.

FIG. 12 is a schematic flowchart of another information transmission method shown according to an exemplary embodiment.

FIG. 13 is a block diagram of an information transmission apparatus shown according to an exemplary embodiment.

FIG. 14 is a block diagram of another information transmission apparatus shown according to an exemplary embodiment.

FIG. 15 is a schematic structural diagram of an information transmission apparatus shown according to an exemplary embodiment of the present disclosure.

FIG. 16 is a schematic structural diagram of another information transmission apparatus shown according to an exemplary embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not intended to limit the present disclosure. Singular forms, “a/an,” “the,” and “this,” used in the present disclosure and the appended claims are also intended to include majority forms, unless the context clearly indicates other meanings. It should also be understood that the term “and/or” used herein refers to and includes any or all possible combinations of at least one related listed item.

It should be understood that although terms, such as “first,” “second,” “third,” etc., may be used in the present disclosure to describe various information, such information should not be limited by these terms. These terms are only used to distinguish a same type of information from each other. For example, without departing from the scope of the present disclosure, first information may also be referred to as second information, and similarly, the second information may also be referred to as the first information. Depending on the context, the term “if”' used herein may be interpreted as “when,” “while,” or “in response to determining.”

The information transmission method provided in the present disclosure is described firstly from a side of a base station below.

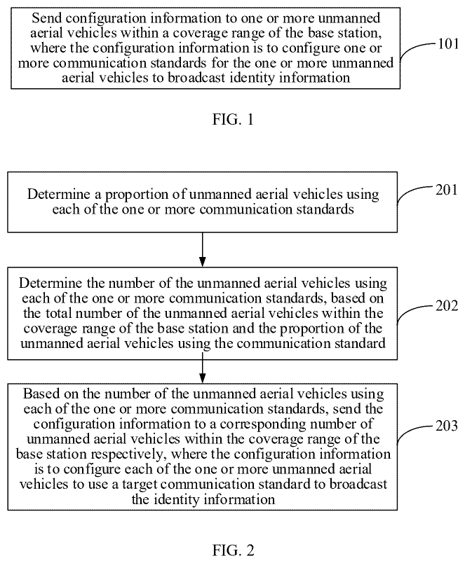

An embodiment of the present disclosure provides an information transmission method. Referring to FIG. 1, FIG. 1 is a flowchart of an information transmission method shown according to an embodiment. The method may be performed by a base station. The method may include the following step 101.

At step 101, configuration information is sent to one or more unmanned aerial vehicles within a coverage range of the base station, where the configuration information is to configure one or more communication standards for the one or more unmanned aerial vehicles to broadcast identity information.

In the embodiment of the present disclosure, the communication standard, for the unmanned aerial vehicle to broadcast the identity information, configured by the base station may be a cellular network communication standard, a WIFI communication standard, or another communication standard, which is not limited in the present disclosure.

In a possible implementation, the identity information may include but is not limited to an identifier of the unmanned aerial vehicle.

In the above embodiment, the base station may send the configuration information to the unmanned aerial vehicles within the coverage range of the base station, to configure, through the configuration information, the communication standards for the one or more unmanned aerial vehicles to broadcast identity information. In the present disclosure, the unmanned aerial vehicle may determine a target communication standard for the unmanned aerial vehicle to broadcast the identity information based on the configuration information sent by the base station, which improves the security and reliability of the unmanned aerial vehicle broadcasting the identity information.

In some optional embodiments, the configuration information may be to configure at least one of: a communication standard for a first-type unmanned aerial vehicle to broadcast the identity information, where the first-type unmanned aerial vehicle supports a plurality of communication standards; or a communication standard for a second-type unmanned aerial vehicle to broadcast the identity information, where the second-type unmanned aerial vehicle supports one communication standard.

In a possible implementation, the first-type unmanned aerial vehicle may support at least the cellular network communication standard and the WIFI communication standard. The second-type unmanned aerial vehicle may only support the cellular network communication standard, or only support the WIFI communication standard.

In the above embodiment, the base station may configure, for different types of unmanned aerial vehicles, the communication standards for the unmanned aerial vehicles to broadcast the identity information through the configuration information, which improves the security and reliability of the unmanned aerial vehicle broadcasting the identity information.

In some optional embodiments, the configuration information may be to configure at least one of: the first-type unmanned aerial vehicle to use one of the plurality of communication standards supported by the first-type unmanned aerial vehicle in turn to broadcast the identity information; or the second-type unmanned aerial vehicle to use the communication standard supported by the second-type unmanned aerial vehicle to broadcast the identity information.

In a possible implementation, the first-type unmanned aerial vehicle supports at least the cellular network communication standard and the WIFI communication standard, and the first-type unmanned aerial vehicle may use one of the cellular network communication standard and the WIFI communication standard in turn to broadcast the identity information.

In a possible implementation, if the second-type unmanned aerial vehicle supports the WIFI communication standard, the second-type unmanned aerial vehicle may use the WIFI communication standard to broadcast the identity information based on the configuration information. If the second-type unmanned aerial vehicle supports the cellular network communication standard, the second-type unmanned aerial vehicle may use the cellular network communication standard to broadcast the identity information based on the configuration information.

In the above embodiments, the base station may configure, through the configuration information, the first-type unmanned aerial vehicle to use one of the plurality of communication standards supported by the first-type unmanned aerial vehicle in turn to broadcast the identity information, and the second-type unmanned aerial vehicle to use the communication standard supported by the second-type unmanned aerial vehicle to broadcast the identity information, which improves the security and reliability of the unmanned aerial vehicle broadcasting the identity information.

In some optional embodiments, the configuration information may be to configure at least one of: a time point at which the first-type unmanned aerial vehicle broadcasts the identity information with at least one of the plurality of communication standards; a frequency at which the first-type unmanned aerial vehicle broadcasts the identity information with at least one of the plurality of communication standards; a period at which the first-type unmanned aerial vehicle broadcasts the identity information with at least one of the plurality of communication standards; or a power at which the first-type unmanned aerial vehicle broadcasts the identity information with at least one of the plurality of communication standards. The first-type unmanned aerial vehicle at least supports the cellular network communication standard and the WIFI communication standard.

In a possible implementation, the configuration information may be to configure at least one of: a time point at which the first-type unmanned aerial vehicle uses the cellular network communication standard; a frequency at which the first-type unmanned aerial vehicle uses the cellular network communication standard; a period at which the first-type unmanned aerial vehicle uses the cellular network communication standard; or a power at which the first-type unmanned aerial vehicle uses the cellular network communication standard.

In another possible implementation, the configuration information may be to configure at least one of: a time point at which the first-type unmanned aerial vehicle uses the WIFI communication standard; a frequency at which the first-type unmanned aerial vehicle uses the WIFI communication standard; a period at which the first-type unmanned aerial vehicle uses the WIFI communication standard; or a power at which the first-type unmanned aerial vehicle uses the WIFI communication standard.

In the embodiment of the present disclosure, it should be noted that if the first-type unmanned aerial vehicle supports two communication standards, and the base station configures, through configuration information, at least one of the time point, the frequency, or the period at which the unmanned aerial vehicle uses one of the two communication standards to broadcast the identity information, the unmanned aerial vehicle may determine, based on the configuration information, the time point at which the unmanned aerial vehicle uses the communication standard to broadcast the identity information, and further, the unmanned aerial vehicle may use the other communication standard to broadcast the identity information at another time point.

In another possible implementation, the configuration information may be to configure at least one of: a time point at which the first-type unmanned aerial vehicle uses the cellular network communication standard; a frequency at which the first-type unmanned aerial vehicle uses the cellular network communication standard; a period at which the first-type unmanned aerial vehicle uses the cellular network communication standard; a power at which the first-type unmanned aerial vehicle uses the cellular network communication standard; a time point at which the first-type unmanned aerial vehicle uses the WIFI communication standard; a frequency at which the first-type unmanned aerial vehicle uses the WIFI communication standard; a period at which the first-type unmanned aerial vehicle uses the WIFI communication standard; or a power at which the first-type unmanned aerial vehicle uses the WIFI communication standard.

In a possible implementation, the configuration information may be to configure at least one of: a time point at which the second-type unmanned aerial vehicle broadcasts the identity information with the communication standard supported by the second-type unmanned aerial vehicle; a frequency at which the second-type unmanned aerial vehicle broadcasts the identity information with the communication standard supported by the second-type unmanned aerial vehicle; a period at which the second-type unmanned aerial vehicle broadcasts the identity information with the communication standard supported by the second-type unmanned aerial vehicle; or a power at which the second-type unmanned aerial vehicle broadcasts the identity information with the communication standard supported by the second-type unmanned aerial vehicle.

In the embodiment of the present disclosure, in addition to configuring the communication standard, supported by the second-type unmanned aerial vehicle, for the second-type unmanned aerial vehicle to broadcast the identity information, the configuration information may further configure a time point, a frequency, a period, a power, etc., at which the second-type unmanned aerial vehicle broadcasts the identity information with the supported communication standard.

In a possible implementation, the configuration information may be to configure at least one of: a time point at which the first-type unmanned aerial vehicle broadcasts the identity information with at least one of the plurality of communication standards; a frequency at which the first-type unmanned aerial vehicle broadcasts the identity information with at least one of the plurality of communication standards; a period at which the first-type unmanned aerial vehicle broadcasts the identity information with at least one of the plurality of communication standards; a power at which the first-type unmanned aerial vehicle broadcasts the identity information with at least one of the plurality of communication standards; a time point at which the second-type unmanned aerial vehicle broadcasts the identity information with the communication standard supported by the second-type unmanned aerial vehicle; a frequency at which the second-type unmanned aerial vehicle broadcasts the identity information with the communication standard supported by the second-type unmanned aerial vehicle; a period at which the second-type unmanned aerial vehicle broadcasts the identity information with the communication standard supported by the second-type unmanned aerial vehicle; or a power at which the second-type unmanned aerial vehicle broadcasts the identity information with the communication standard supported by the second-type unmanned aerial vehicle.

That is, the base station may configure, for the first-type unmanned aerial vehicle and the second-type unmanned aerial vehicle, a time point, a frequency, a period, a power, etc., at which the first-type or second-type unmanned aerial vehicle broadcasts the identity information with the corresponding communication standard.

In the above embodiment, the base station may configure, for different types of unmanned aerial vehicles, the communication standards for the unmanned aerial vehicles to broadcast the identity information through the configuration information, which improves the security and reliability of the unmanned aerial vehicle broadcasting the identity information.

In some optional embodiments, the configuration information may be to configure a correspondence between a flight parameter value of the first-type unmanned aerial vehicle and the communication standard for the first-type unmanned aerial vehicle to broadcast the identity information.

In a possible implementation, the flight parameter value may include at least one of: a flight speed value or a flight height value.

In a possible implementation, the configuration information is to configure at least one of: a communication standard, when the flight parameter value of the first-type unmanned aerial vehicle is larger than or equal to a preset threshold, for the first-type unmanned aerial vehicle to broadcast the identity information; a communication standard, when the flight parameter value of the first-type unmanned aerial vehicle is less than the preset threshold, for the first-type unmanned aerial vehicle to broadcast the identity information; or the first-type unmanned aerial vehicle to determine, when the flight parameter value of the first-type unmanned aerial vehicle is within a preset threshold range, a communication standard for the first-type unmanned aerial vehicle to broadcast the identity information.

In a possible implementation, the configuration information may be to configure: the first-type unmanned aerial vehicle to use the cellular network communication standard to broadcast the identity information, when the flight speed value of the first-type unmanned aerial vehicle is larger than or equal to a first preset threshold; the first-type unmanned aerial vehicle to use the WIFI communication standard to broadcast the identity information, when the flight speed value of the first-type unmanned aerial vehicle is less than the first preset threshold; and the first-type unmanned aerial vehicle, supported by the base station, to use any one communication standard to broadcast the identity information, when the flight speed value of the first-type unmanned aerial vehicle is within a first preset threshold range, where the first-type unmanned aerial vehicle itself may determine which communication standard it uses specifically.

In another possible implementation, the configuration information may be to configure that: the first-type unmanned aerial vehicle uses the cellular network communication standard to broadcast the identity information, when the flight height value of the first-type unmanned aerial vehicle is larger than or equal to a second preset threshold; the first-type unmanned aerial vehicle uses the WIFI communication standard to broadcast the identity information, when the flight height value of the first-type unmanned aerial vehicle is less than the second preset threshold; and the base station supports the first-type unmanned aerial vehicle to use any one communication standard to broadcast the identity information, when the flight height value of the first-type unmanned aerial vehicle is within a second preset threshold range, where the first-type unmanned aerial vehicle itself may determine which communication standard it uses specifically.

The first preset threshold and the second preset threshold may be configured by the base station or agreed by a protocol, which is not limited in the present disclosure, and the first preset threshold may be same as or different from the second preset threshold.

The first preset threshold range and the second preset threshold range may be configured by the base station or agreed by a protocol, which is not limited in the present disclosure, and the first preset threshold range may be different from the second preset threshold range.

In the above embodiment, the base station may configure, through the configuration information, the correspondence between the flight parameter value of the first-type unmanned aerial vehicle and the communication standard for the first-type unmanned aerial vehicle to broadcast the identity information, and the first-type unmanned aerial vehicle may determine, based on the flight parameter value of the first-type unmanned aerial vehicle and the correspondence, the target communication standard for the first-type unmanned aerial vehicle to broadcast the identity information, which improves the security and reliability of the unmanned aerial vehicle broadcasting the identity information.

In some optional embodiments, referring to FIG. 2, FIG. 2 is a flowchart of an information transmission method shown according to an embodiment. The method may be performed by a base station. The method may include the following steps 201-203.

At step 201, a proportion of unmanned aerial vehicles using each of the one or more communication standards is determined.

In the embodiment of the present disclosure, the base station may determine the proportion of the unmanned aerial vehicles using the cellular network communication standard and the proportion of the unmanned aerial vehicles using the WIFI communication standard.

At step 202, the number of the unmanned aerial vehicles using each of the one or more communication standards is determined, based on the total number of the unmanned aerial vehicles within the coverage range of the base station and the proportion of the unmanned aerial vehicles using the communication standard.

At step 203, based on the number of the unmanned aerial vehicles using each of the one or more communication standards, the configuration information is sent to a corresponding number of unmanned aerial vehicles within the coverage range of the base station respectively, where the configuration information is to configure each of the one or more unmanned aerial vehicles to use a target communication standard to broadcast the identity information.

For example, the base station first determines the proportion of the unmanned aerial vehicles using the cellular network communication standard and the proportion of the unmanned aerial vehicles using the WIFI network communication standard, for example, a % and b %, where a sum of a % and b % may be 100%. It is set that the total number of the unmanned aerial vehicles within the coverage range of the base station is A, the base station may determine that the number of the unmanned aerial vehicles using the cellular network communication standard and the number of the unmanned aerial vehicles using the WIFI communication standard are A×a % and A×b %, respectively. It is set that specific numbers thereof are N and M, the base station may first send configuration information to N unmanned aerial vehicles within the coverage range, where the configuration information directly indicates the cellular network communication standard for the unmanned aerial vehicles to broadcast the identity information; and then, the base station may send configuration information to M unmanned aerial vehicles within the coverage range, where the configuration information directly indicates the WIFI communication standard for the unmanned aerial vehicles to broadcast the identity information. The sequence of sending the configuration information is not limited in the present disclosure.

In the above embodiment, for each of the communication standards, the base station may determine the proportion of unmanned aerial vehicles using the communication standard, to control, based on the configuration information, the unmanned aerial vehicles within the coverage range to use the corresponding communication standard based on the proportion to broadcast the identity information, which improves the security and reliability of the unmanned aerial vehicle broadcasting the identity information.

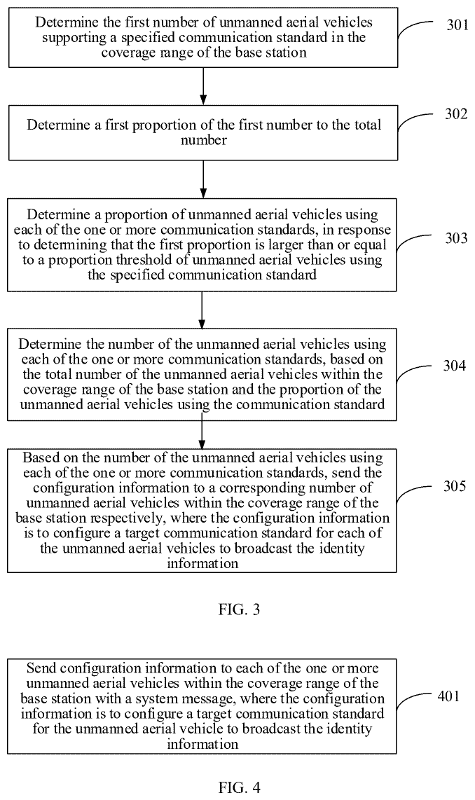

In some optional embodiments, referring to FIG. 3, FIG. 3 is a flowchart of an information transmission method shown according to an embodiment. The method may be performed by a base station. The method may include the following steps 301-305.

At step 301, the first number of unmanned aerial vehicles supporting a specified communication standard within the coverage range of the base station is determined.

In a possible implementation, the specified communication standard may be a WIFI communication standard.

In another possible implementation, the specified communication standard may be a cellular network communication standard.

In another possible implementation, the specified communication standard may be the WIFI communication standard and the cellular network communication standard.

At step 302, a first proportion of the first number to the total number is determined.

At step 303, a proportion of unmanned aerial vehicles using each of the one or more communication standards is determined, in response to determining that the first proportion is larger than or equal to a proportion threshold of unmanned aerial vehicles using the specified communication standard.

The proportion threshold for the cellular network communication standard may be different from the proportion threshold for the WIFI communication standard. The proportion threshold may be configured by the base station, or may be agreed by a protocol, which is not limited in the present disclosure.

In a possible implementation, if the base station determines that the first proportion of unmanned aerial vehicles supporting the WIFI communication standard in the coverage of the base station is greater than or equal to the proportion threshold for the WIFI communication standard, the base station may determine a proportion of unmanned aerial vehicles using each of the communication standards.

In another possible implementation, if the base station determines that the first proportion of unmanned aerial vehicles supporting the cellular network communication standard in the coverage of the base station is greater than or equal to the proportion threshold for the cellular network communication standard, the base station may determine a proportion of unmanned aerial vehicles using each of the communication standards.

In another possible implementation, if the base station determines that the first proportion of the unmanned aerial vehicles supporting the WIFI communication standard and the first proportion of the unmanned aerial vehicles supporting the cellular network communication standard in the coverage of the base station are greater than or equal to the proportion threshold for the WIFI communication standard and the proportion threshold for the cellular network communication standard respectively, the base station may determine a proportion of unmanned aerial vehicles using each of the communication standards.

At step 304, the number of the unmanned aerial vehicles using each of the one or more communication standards is determined, based on the total number of the unmanned aerial vehicles within the coverage range of the base station and the proportion of the unmanned aerial vehicles using the communication standard.

At step 305, based on the number of the unmanned aerial vehicles using each of the one or more communication standards, the configuration information is sent to a corresponding number of unmanned aerial vehicles within the coverage range of the base station respectively, where the configuration information is to configure a target communication standard for each of the unmanned aerial vehicles to broadcast the identity information.

In the above embodiment, for each of the communication standards, the base station may determine the proportion of unmanned aerial vehicles using the communication standard, to control, based on the configuration information, the unmanned aerial vehicles within the coverage range to use the corresponding communication standard based on the proportion to broadcast the identity information, which improves the security and reliability of the unmanned aerial vehicle broadcasting the identity information.

In some optional embodiments, referring to FIG. 4, FIG. 4 is a flowchart of an information transmission method shown according to an embodiment. The method may be performed by a base station. The method may include the following step 401.

At step 401, configuration information is sent to each of the one or more unmanned aerial vehicles within the coverage range of the base station with a system message, where the configuration information is to configure a target communication standard for the unmanned aerial vehicle to broadcast the identity information.

In the embodiment of the present disclosure, no matter whether the unmanned aerial vehicle is in a connected state, an idle state, or an inactive state, the base station may send the configuration information to the unmanned aerial vehicle with the system message.

In the above embodiment, the base station may send the configuration information to the unmanned aerial vehicle with the system message, so that the unmanned aerial vehicle broadcasts the identity information based on the configuration information sent by the base station, which improves the security and reliability of the unmanned aerial vehicle broadcasting the identity information.

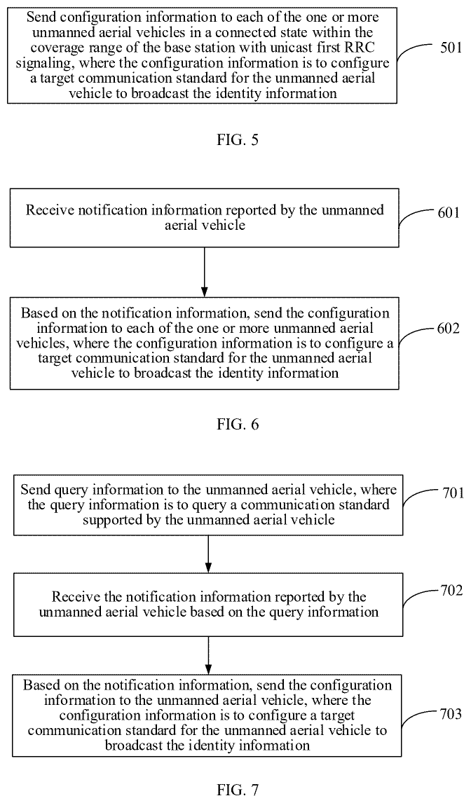

In some optional embodiments, referring to FIG. 5, FIG. 5 is a flowchart of an information transmission method shown according to an embodiment. The method may be performed by a base station. The method may include the following step 501.

At step 501, configuration information is sent to each of the one or more unmanned aerial vehicles in a connected state within the coverage range of the base station with unicast first RRC signaling, where the configuration information is to configure a target communication standard for the unmanned aerial vehicle to broadcast the identity information.

In the above embodiment, the base station may send the configuration information to the unmanned aerial vehicle in the connected state with the unicast RRC signaling, so that the unmanned aerial vehicle broadcasts the identity information based on the configuration information sent by the base station, which improves the security and reliability of the unmanned aerial vehicle broadcasting the identity information.

In some optional embodiments, referring to FIG. 6, FIG. 6 is a flowchart of an information transmission method shown according to an embodiment. The method may be performed by a base station. The method may include the following steps 601-602.

At step 601, notification information reported by an unmanned aerial vehicle is received.

In a possible implementation, the notification information is to at least notify the base station of a communication standard supported by the unmanned aerial vehicle.

In another possible implementation, the notification information is to notify the base station of the communication standards supported by the unmanned aerial vehicle and notify the base station of capability information for the communication standard supported by the unmanned aerial vehicle.

Specifically, in a case where the notification information is to notify the base station of capability information for the WIFI communication standard supported by the unmanned aerial vehicle, the capability information for the WIFI communication standard includes but is not limited to at least one of: a WIFI version; or a maximum transmitting power.

At step 602, based on the notification information, the configuration information is sent to each of the one or more unmanned aerial vehicles, where the configuration information is to configure a target communication standard for the unmanned aerial vehicle to broadcast the identity information.

In the above embodiment, the base station may send the configuration information to the unmanned aerial vehicle after determining, based on the notification information reported by the unmanned aerial vehicle, the communication standard supported by the unmanned aerial vehicle, so that the unmanned aerial vehicle broadcasts the identity information based on the configuration information sent by the base station, which improves the security and reliability of the unmanned aerial vehicle broadcasting the identity information.

In a possible implementation, the base station may receive the notification information reported by the unmanned aerial vehicle with second RRC signaling.

Specifically, the second RRC signaling may include at least one of: user equipment evolved universal mobile telecommunication system terrestrial radio access network capability (UE-EUTRA-capacity) signaling; user equipment multi-radio technology dual-connectivity capability (UE-MRDC-capacity) signaling; or user equipment new radio capability (UE-NR-capability) signaling.

In some optional embodiments, referring to FIG. 7, FIG. 7 is a flowchart of an information transmission method shown according to an embodiment. The method may be performed by a base station. The method may include the following steps 701-703.

At step 701, query information is sent to the unmanned aerial vehicle, where the query information is to query a communication standard supported by the unmanned aerial vehicle.

At step 702, the notification information reported by the unmanned aerial vehicle based on the query information is received.

In a possible implementation, the notification information is to at least notify the base station of a communication standard supported by the unmanned aerial vehicle.

In another possible implementation, the communication standards supported by the unmanned aerial vehicle include at least the WIFI communication standard; and the notification information is to notify the base station of the communication standards supported by the unmanned aerial vehicle and notify the base station of capability information for the WIFI communication standard supported by the unmanned aerial vehicle.

Specifically, the capability information for the WIFI communication standard includes but is not limited to at least one of: a WIFI version or a maximum transmitting power.

At step 703, based on the notification information, the configuration information is sent to the unmanned aerial vehicle, where the configuration information is to configure a target communication standard for the unmanned aerial vehicle to broadcast the identity information.

In the above embodiment, the base station may first send the query information to the unmanned aerial vehicle, the unmanned aerial vehicle reports the notification information to the base station based on the query information, and the base station may send the configuration information to the unmanned aerial vehicle after determining, based on the notification information, the communication standards supported by the unmanned aerial vehicle, so that the unmanned aerial vehicle broadcasts the identity information based on the configuration information sent by the base station, which improves the security and reliability of the unmanned aerial vehicle broadcasting the identity information.

In a possible implementation, the base station may send the query information to the unmanned aerial vehicle with third RRC signaling.

Specifically, the third RRC signaling may be UE capability enquiry signaling.

In a possible implementation, the query information may be to query whether the unmanned aerial vehicle supports a specified communication standard. The specified communication standard may include at least one of the WIFI communication standard or the cellular network communication standard, which is not limited in the present disclosure.

The information transmission method provided in the present disclosure is described again from a side of an unmanned aerial vehicle below.

An embodiment of the present disclosure provides an information transmission method. Referring to FIG. 8, FIG. 8 is a flowchart of an information transmission method shown according to an embodiment. The method may be performed by an unmanned aerial vehicle. The method may include the following steps 801-803.

At step 801, configuration information sent by a base station is received, where the unmanned aerial vehicle is within a coverage range of the base station, and the configuration information is to configure a communication standard for the unmanned aerial vehicle to broadcast identity information.

At step 802, based on the configuration information, a target communication standard for the unmanned aerial vehicle to broadcast the identity information is determined.

At step 803, the identity information is broadcast based on the target communication standard.

In the embodiment of the present disclosure, the unmanned aerial vehicle may select a communication module for the target communication standard from communication modules supported by the unmanned aerial vehicle to broadcast the identity information. The identity information at least includes an identifier of the unmanned aerial vehicle.

In the above embodiment, the unmanned aerial vehicle determines a target communication standard for the unmanned aerial vehicle to broadcast the identity information based on the configuration information sent by the base station, which improves the security and reliability of the unmanned aerial vehicle broadcasting the identity information.

In some optional embodiments, the configuration information is to configure at least one of: a communication standard for a first-type unmanned aerial vehicle to broadcast the identity information, where the first-type unmanned aerial vehicle supports a plurality of communication standards; or a communication standard for a second-type unmanned aerial vehicle to broadcast the identity information, where the second-type unmanned aerial vehicle supports one communication standard.

Correspondingly, if the unmanned aerial vehicle determines the type thereof, the unmanned aerial vehicle determines the target communication standard used to broadcast the identity information based on the configuration information. Further, the unmanned aerial vehicle may select a communication module for the target communication standard from communication modules supported by the unmanned aerial vehicle to broadcast the identity information. The identity information at least includes an identifier of the unmanned aerial vehicle.

In the above embodiment, the unmanned aerial vehicle determines a target communication standard for the unmanned aerial vehicle to broadcast the identity information based on the configuration information sent by the base station, which improves the security and reliability of the unmanned aerial vehicle broadcasting the identity information.

In some optional embodiments, the configuration information is to configure at least one of: the first-type unmanned aerial vehicle to use one of the plurality of communication standards supported by the first-type unmanned aerial vehicle in turn to broadcast the identity information; or the second-type unmanned aerial vehicle to use the communication standard supported by the second-type unmanned aerial vehicle to broadcast the identity information.

Correspondingly, if the unmanned aerial vehicle determines that the unmanned aerial vehicle belongs to the first-type unmanned aerial vehicle, the unmanned aerial vehicle may determine, based on the configuration information, one of a plurality of communication standards, used in turn to broadcast the identity information, supported by the unmanned aerial vehicle. Further, the unmanned aerial vehicle may select a communication module for the target communication standard from communication modules supported by the unmanned aerial vehicle to broadcast the identity information. The identity information at least includes an identifier of the unmanned aerial vehicle.

In a possible implementation, the first-type unmanned aerial vehicle supports at least the cellular network communication standard and the WIFI communication standard, and the first-type unmanned aerial vehicle may use one of the cellular network communication standard and the WIFI communication standard in turn to broadcast the identity information. That is, the first-type unmanned aerial vehicle uses one of the cellular network communication module and the WIFI communication module in turn to broadcast the identity information.

If the unmanned aerial vehicle determines that the unmanned aerial vehicle belongs to the second-type unmanned aerial vehicle, the unmanned aerial vehicle may determine, based on the configuration information, the communication standard, used to broadcast the identity information, supported by the unmanned aerial vehicle.

In a possible implementation, if the second-type unmanned aerial vehicle supports the WIFI communication standard, the second-type unmanned aerial vehicle may use the WIFI communication standard to broadcast the identity information based on the configuration information. If the second-type unmanned aerial vehicle supports the cellular network communication standard, the second-type unmanned aerial vehicle may use the cellular network communication standard to broadcast the identity information based on the configuration information. The second-type unmanned aerial vehicle broadcasts the identity information by a communication module supported by the second-type unmanned aerial vehicle.

In the above embodiment, the unmanned aerial vehicle determines a target communication standard for the unmanned aerial vehicle to broadcast the identity information based on the configuration information sent by the base station, which improves the security and reliability of the unmanned aerial vehicle broadcasting the identity information.

In some optional embodiments, the configuration information may be to configure at least one of: a time point at which the first-type unmanned aerial vehicle broadcasts the identity information with at least one of the plurality of communication standards; a frequency at which the first-type unmanned aerial vehicle broadcasts the identity information with at least one of the plurality of communication standards; a period at which the first-type unmanned aerial vehicle broadcasts the identity information with at least one of the plurality of communication standards; or a power at which the first-type unmanned aerial vehicle broadcasts the identity information with at least one of the plurality of communication standards. The first-type unmanned aerial vehicle at least supports the cellular network communication standard and the WIFI communication standard.

In a possible implementation, the configuration information may be to configure at least one of: a time point at which the first-type unmanned aerial vehicle uses the cellular network communication standard; a frequency at which the first-type unmanned aerial vehicle uses the cellular network communication standard; a period at which the first-type unmanned aerial vehicle uses the cellular network communication standard; or a power at which the first-type unmanned aerial vehicle uses the cellular network communication standard.

In another possible implementation, the configuration information may be to configure at least one of: a time point at which the first-type unmanned aerial vehicle uses the WIFI communication standard; a frequency at which the first-type unmanned aerial vehicle uses the WIFI communication standard; a period at which the first-type unmanned aerial vehicle uses the WIFI communication standard; or a power at which the first-type unmanned aerial vehicle uses the WIFI communication standard.

In the embodiment of the present disclosure, the unmanned aerial vehicle may determine, based on the time point for broadcasting the identity information and the configuration information, whether to use the cellular network communication standard or the WIFI communication standard to broadcast the identity information. The unmanned aerial vehicle may use one of the cellular network communication module and the WIFI communication module to broadcast the identity information.

It should be noted that if the unmanned aerial vehicle belongs to the first-type unmanned aerial vehicle and supports at least two communication standards, and the base station configures, through configuration information, at least one of the time point, the frequency, or the period at which the unmanned aerial vehicle uses one of the two communication standards to broadcast the identity information, the unmanned aerial vehicle may determine, based on the configuration information, the time point at which the unmanned aerial vehicle uses the communication standard to broadcast the identity information, and further, the unmanned aerial vehicle may use the other communication standard to broadcast the identity information at another time point, that is, select the other communication module to broadcast the identity information.

In another possible implementation, the configuration information may be to configure at least one of: a time point at which the first-type unmanned aerial vehicle uses the cellular network communication standard; a frequency at which the first-type unmanned aerial vehicle uses the cellular network communication standard; a period at which the first-type unmanned aerial vehicle uses the cellular network communication standard; a power at which the first-type unmanned aerial vehicle uses the cellular network communication standard; a time point at which the first-type unmanned aerial vehicle uses the WIFI communication standard; a frequency at which the first-type unmanned aerial vehicle uses the WIFI communication standard; a period at which the first-type unmanned aerial vehicle uses the WIFI communication standard; or a power at which the first-type unmanned aerial vehicle uses the WIFI communication standard.

The unmanned aerial vehicle may directly determine, based on the configuration information, whether to use the cellular network communication standard or the WIFI communication standard to broadcast the identity information.

In the above embodiment, the base station may configure, for different types of unmanned aerial vehicles, the communication standards for the unmanned aerial vehicles to broadcast the identity information through the configuration information, which improves the security and reliability of the unmanned aerial vehicle broadcasting the identity information.

In some optional embodiments, the configuration information may be to configure a correspondence between a flight parameter value of the first-type unmanned aerial vehicle and the communication standard for the first-type unmanned aerial vehicle to broadcast the identity information.

In a possible implementation, the flight parameter value may include at least one of: a flight speed value or a flight height value.

In a possible implementation, the configuration information is to configure at least one of: a communication standard, when the flight parameter value of the first-type unmanned aerial vehicle is larger than or equal to a preset threshold, for the first-type unmanned aerial vehicle to broadcast the identity information; a communication standard, when the flight parameter value of the first-type unmanned aerial vehicle is less than the preset threshold, for the first-type unmanned aerial vehicle to broadcast the identity information; or the first-type unmanned aerial vehicle to determine, when the flight parameter value of the first-type unmanned aerial vehicle is within a preset threshold range, a communication standard for the first-type unmanned aerial vehicle to broadcast the identity information.

In a possible implementation, the configuration information may be to configure that: the first-type unmanned aerial vehicle uses the cellular network communication standard to broadcast the identity information, when the flight speed value of the first-type unmanned aerial vehicle is larger than or equal to a first preset threshold; the first-type unmanned aerial vehicle uses the WIFI communication standard to broadcast the identity information, when the flight speed value of the first-type unmanned aerial vehicle is less than the first preset threshold; and the base station supports the first-type unmanned aerial vehicle to use any one communication standard to broadcast the identity information, when the flight speed value of the first-type unmanned aerial vehicle is within a first preset threshold range, where the first-type unmanned aerial vehicle itself may determine which communication standard it uses specifically.

Specifically, if the unmanned aerial vehicle determines that the unmanned aerial vehicle belongs to the first-type unmanned aerial vehicle, and the flight speed value thereof is greater than or equal to the first preset threshold, the unmanned aerial vehicle uses the cellular network communication standard as the target communication standard, and uses the cellular network communication standard to broadcast the identity information, that is, selects the cellular network communication module to broadcast the identity information.

If the unmanned aerial vehicle determines that the unmanned aerial vehicle belongs to the first-type unmanned aerial vehicle, and the flight speed value thereof is less than the first preset threshold, the unmanned aerial vehicle uses the WIFI communication standard as the target communication standard, and uses the WIFI communication standard to broadcast the identity information, that is, selects the WIFI communication module to broadcast the identity information.

If the unmanned aerial vehicle determines that the unmanned aerial vehicle belongs to the first-type unmanned aerial vehicle, and the flight speed value thereof is within the first preset threshold range, the unmanned aerial vehicle may select one of the cellular network communication standard or the WIFI communication standard as the target communication standard, and uses the selected communication standard to broadcast the identity information, that is, selects a corresponding communication module to broadcast the identity information.

In another possible implementation, the configuration information may be to configure that: the first-type unmanned aerial vehicle uses the cellular network communication standard to broadcast the identity information, when the flight height value of the first-type unmanned aerial vehicle is larger than or equal to a second preset threshold; the first-type unmanned aerial vehicle uses the WIFI communication standard to broadcast the identity information, when the flight height value of the first-type unmanned aerial vehicle is less than the second preset threshold; and the base station supports the first-type unmanned aerial vehicle to use any one communication standard to broadcast the identity information, when the flight height value of the first-type unmanned aerial vehicle is within a second preset threshold range, where the first-type unmanned aerial vehicle itself may determine which communication standard it uses specifically.

Specifically, if the unmanned aerial vehicle determines that the unmanned aerial vehicle belongs to the first-type unmanned aerial vehicle, and the flight height value thereof is greater than or equal to the second preset threshold, the unmanned aerial vehicle uses the cellular network communication standard as the target communication standard, and uses the cellular network communication standard to broadcast the identity information, that is, selects the cellular network communication module to broadcast the identity information.

If the unmanned aerial vehicle determines that the unmanned aerial vehicle belongs to the first-type unmanned aerial vehicle, and the flight height value thereof is less than the second preset threshold, the unmanned aerial vehicle uses the WIFI communication standard as the target communication standard, and uses the WIFI communication standard to broadcast the identity information, that is, selects the WIFI communication module to broadcast the identity information.

If the unmanned aerial vehicle determines that the unmanned aerial vehicle belongs to the first-type unmanned aerial vehicle, and the flight height value thereof is within the second preset threshold range, the unmanned aerial vehicle may select one of the cellular network communication standard or the WIFI communication standard as the target communication standard, and uses the selected communication standard to broadcast the identity information, that is, selects a corresponding communication module to broadcast the identity information.

The first preset threshold and the second preset threshold may be configured by the base station or agreed by a protocol, which is not limited in the present disclosure, and the first preset threshold may be same as or different from the second preset threshold.

The first preset threshold range and the second preset threshold range may be configured by the base station or agreed by a protocol, which is not limited in the present disclosure, and the first preset threshold range may be different from the second preset threshold range.

In the above embodiment, the unmanned aerial vehicle may determine a target communication standard for the unmanned aerial vehicle to broadcast the identity information based on the configuration information sent by the base station, which improves the security and reliability of the unmanned aerial vehicle broadcasting the identity information.

In some optional embodiments, for each of the communication standards, the base station may determine the proportion of unmanned aerial vehicles using the communication standard, and determine the number of the unmanned aerial vehicles using the communication standard, based on the total number of the unmanned aerial vehicles within the coverage range of the base station and the proportion of the unmanned aerial vehicles using the communication standard. Further, for each of the communication standards, the base station sends, based on the number of the unmanned aerial vehicles using the communication standard, the configuration information to a corresponding number of unmanned aerial vehicles within the coverage range of the base station respectively, where the configuration information is to configure a target communication standard for each of the unmanned aerial vehicles to broadcast the identity information. After receiving the configuration information, the unmanned aerial vehicle may directly select the communication module for the target communication standard when broadcasting (or, to broadcast) the identity information.

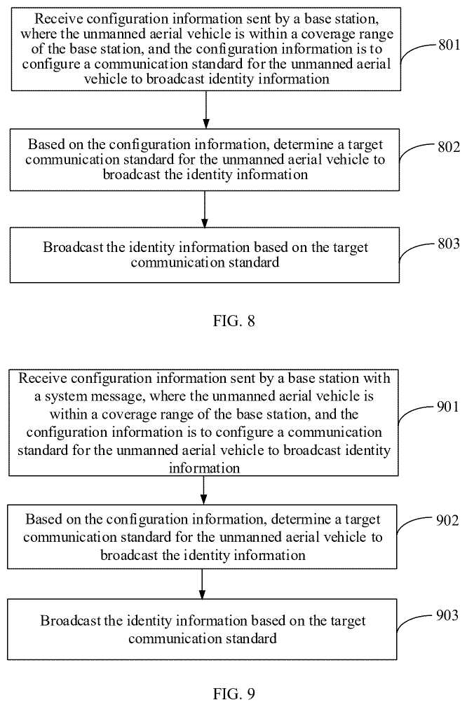

In some optional embodiments, referring to FIG. 9, FIG. 9 is a flowchart of an information transmission method shown according to an embodiment. The method may be performed by an unmanned aerial vehicle. The method may include the following steps 901-903.

At step 901, configuration information sent by a base station with a system message is received, where the unmanned aerial vehicle is within a coverage range of the base station, and the configuration information is to configure a communication standard for the unmanned aerial vehicle to broadcast identity information.

In the embodiment of the present disclosure, the unmanned aerial vehicle may be in a connected state, an idle state, or an inactive state, and the unmanned aerial vehicle may obtain the configuration information with a system message.

At step 902, based on the configuration information, a target communication standard for the unmanned aerial vehicle to broadcast the identity information is determined.

The manner of determining the target communication standard has been described in the above embodiments, and will be not repeated herein.

At step 903, the identity information is broadcast based on the target communication standard.

In the above embodiment, the unmanned aerial vehicle may receive the configuration information sent by the base station with the system message, and determine, based on the configuration information, the target communication standard for the unmanned aerial vehicle to broadcast the identity information, which improves the security and reliability of the unmanned aerial vehicle broadcasting the identity information.

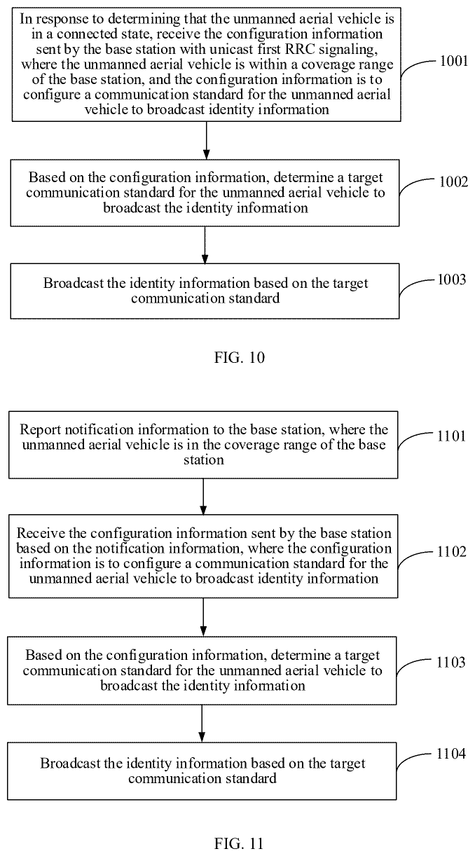

In some optional embodiments, referring to FIG. 10, FIG. 10 is a flowchart of an information transmission method shown according to an embodiment. The method may be performed by an unmanned aerial vehicle. The method may include the following steps 1001-1003.

At step 1001, in response to determining that the unmanned aerial vehicle is in a connected state, the configuration information sent by the base station with unicast first RRC signaling is received, where the unmanned aerial vehicle is within a coverage range of the base station, and the configuration information is to configure a communication standard for the unmanned aerial vehicle to broadcast identity information.

At step 1002, based on the configuration information, a target communication standard for the unmanned aerial vehicle to broadcast the identity information is determined.

At step 1003, the identity information is broadcast based on the target communication standard.

In the above embodiment, the unmanned aerial vehicle in the connected state may receive the configuration information sent by the base station with the unicast RRC signaling, and determine, based on the configuration information, the target communication standard for the unmanned aerial vehicle to broadcast the identity information, which improves the security and reliability of the unmanned aerial vehicle broadcasting the identity information.

In some optional embodiments, referring to FIG. 11, FIG. 11 is a flowchart of an information transmission method shown according to an embodiment. The method may be performed by an unmanned aerial vehicle. The method may include the following steps 1101-1104.

At step 1101, notification information is reported to the base station, where the unmanned aerial vehicle is within the coverage range of the base station.

In a possible implementation, the notification information is to at least notify the base station of a communication standard supported by the unmanned aerial vehicle.

In another possible implementation, the notification information is to notify the base station of the communication standards supported by the unmanned aerial vehicle and notify the base station of capability information for the communication standard supported by the unmanned aerial vehicle.

Specifically, in a case where the notification information is to notify the base station of capability information for the WIFI communication standard supported by the unmanned aerial vehicle, the capability information for the WIFI communication standard may include but is not limited to at least one of: a WIFI version; or a maximum transmitting power.

At step 1102, the configuration information sent by the base station based on the notification information is received, where the configuration information is to configure a communication standard for the unmanned aerial vehicle to broadcast identity information.

At step 1103, based on the configuration information, a target communication standard for the unmanned aerial vehicle to broadcast the identity information is determined.

At step 1104, the identity information is broadcast based on the target communication standard.

In the above embodiment, the unmanned aerial vehicle may actively report the notification information to the base station, the base station may send the configuration information to the unmanned aerial vehicle after determining, based on the notification information reported by the unmanned aerial vehicle, the communication standards supported by the unmanned aerial vehicle, so that the unmanned aerial vehicle broadcasts the identity information based on the configuration information sent by the base station, which improves the security and reliability of the unmanned aerial vehicle broadcasting the identity information.

In a possible implementation, the unmanned aerial vehicle may report the notification information to the base station with second RRC signaling.

The second RRC signaling includes at least one of: UE-EUTRA-capability signaling, UE-MRDC-capability signaling, or UE-NR-capability signaling.

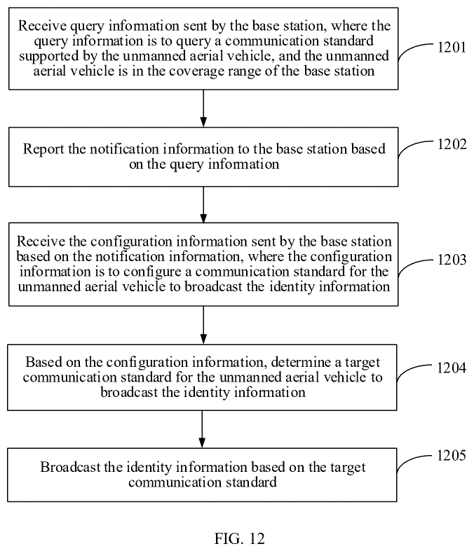

In some optional embodiments, referring to FIG. 12, FIG. 12 is a flowchart of an information transmission method shown according to an embodiment. The method may be performed by an unmanned aerial vehicle. The method may include the following steps 1201-1205.

At step 1201, query information sent by the base station is received, where the query information is to query a communication standard supported by the unmanned aerial vehicle, and the unmanned aerial vehicle is within the coverage range of the base station.

At step 1202, the notification information is reported to the base station based on the query information.

In a possible implementation, the notification information is to at least notify the base station of a communication standard supported by the unmanned aerial vehicle.

In another possible implementation, the communication standards supported by the unmanned aerial vehicles include at least the WIFI communication standard; and the notification information is to notify the base station of the communication standards supported by the unmanned aerial vehicle and notify the base station of capability information for the WIFI communication standard supported by the unmanned aerial vehicle.

Specifically, the capability information for the WIFI communication standard includes but is not limited to at least one of: a WIFI version or a maximum transmitting power.

At step 1203, the configuration information sent by the base station based on the notification information is received, where the configuration information is to configure a communication standard for the unmanned aerial vehicle to broadcast the identity information.

At step 1204, based on the configuration information, a target communication standard for the unmanned aerial vehicle to broadcast the identity information is determined.

At step 1205, the identity information is broadcast based on the target communication standard.

In the above embodiment, the base station may first send the query information to the unmanned aerial vehicle, the unmanned aerial vehicle reports the notification information to the base station based on the query information, and the base station may send the configuration information to the unmanned aerial vehicle after determining, based on the notification information, the communication standards supported by the unmanned aerial vehicle, so that the unmanned aerial vehicle broadcasts the identity information based on the configuration information sent by the base station, which improves the security and reliability of the unmanned aerial vehicle broadcasting the identity information.

In a possible implementation, the unmanned aerial vehicle may receive the query information sent by the base station with third RRC signaling. Specifically, the third RRC signaling includes UE capability enquiry signaling.

In a possible implementation, the query information is to query whether the unmanned aerial vehicle supports a specified communication standard. The specified communication standard may include at least one of the WIFI communication standard or the cellular network communication standard, which is not limited in the present disclosure.

Corresponding to the above embodiments of information transmission methods, the present disclosure further provides embodiments of information transmission apparatuses.

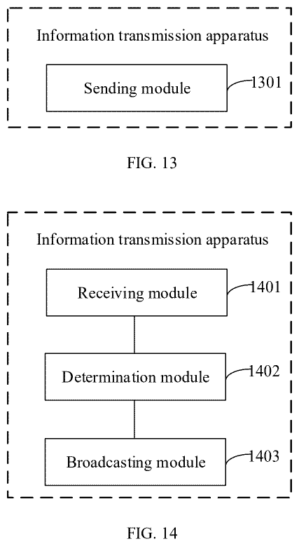

Referring to FIG. 13, FIG. 13 is a block diagram of an information transmission apparatus shown according to an exemplary embodiment. The apparatus is applied to a base station and includes:
a sending module 1301, configured to send configuration information to one or more unmanned aerial vehicles within a coverage range of the base station, where the configuration information is to configure one or more communication standards for the one or more unmanned aerial vehicles to broadcast identity information.

Referring to FIG. 14, FIG. 14 is a block diagram of an information transmission apparatus shown according to an exemplary embodiment. The apparatus is applied to an unmanned aerial vehicle and includes:
a receiving module 1401, configured to receive configuration information sent by a base station, where the unmanned aerial vehicle is within a coverage range of the base station, and the configuration information is to configure a communication standard for the unmanned aerial vehicle to broadcast identity information;
a determination module 1402, configured to determine, based on the configuration information, a target communication standard for the unmanned aerial vehicle to broadcast the identity information; and
a broadcasting module 1403, configured to broadcast the identity information based on the target communication standard.

Since the embodiments of the apparatuses substantially correspond to the embodiments of the methods, and the related contents can refer to the description of the embodiments of the methods. The embodiments of the apparatuses described above are only schematic. The units explained as separate components may be or may not be physically separated, and the components displayed as units may be or may not be physical units, that is, they may be located in one place or may be distributed across a plurality of network units. A part or all of modules may be selected according to actual needs to achieve the purpose of the solutions in the present disclosure. Those skilled in the art may understand and implement other embodiments without a creative work.

Correspondingly, the present disclosure further provide a computer readable storage medium. The computer readable storage medium stores a computer program, and the computer program is configured to perform any one information transmission method in the side of the base station.

Correspondingly, the present disclosure further provide a computer readable storage medium. The computer readable storage medium stores a computer program, and the computer program is configured to perform any one information transmission method in the side of the unmanned aerial vehicle.

Correspondingly, the present disclosure further provides an information transmission apparatus, including:
a processor; and
a memory configured to store instructions executable by the processor;
where the processor is configured to perform any one information transmission method in the side of the base station.

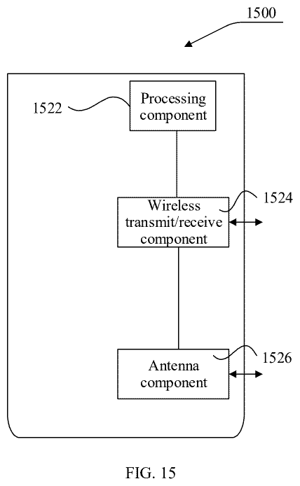

As shown in FIG. 15, FIG. 15 is a schematic structural diagram of an information transmission apparatus 1500 shown according to an exemplary embodiment. The apparatus 1500 may be provided as the base station. Referring to FIG. 15, the apparatus 1500 includes a processing component 1522, a wireless transmit/receive component 1524, an antenna component 1526, and a signal processing part specific to a wireless interface. The processing component 1522 may further include at least one processor.

One processor of the processing component 1522 may be configured to perform any one information transmission method in the side of the base station.

Correspondingly, the present disclosure further provides an information transmission apparatus, including:
a processor; and
a memory configured to store instructions executable by the processor;
where the processor is configured to perform any one information transmission method in the side of the unmanned aerial vehicle.

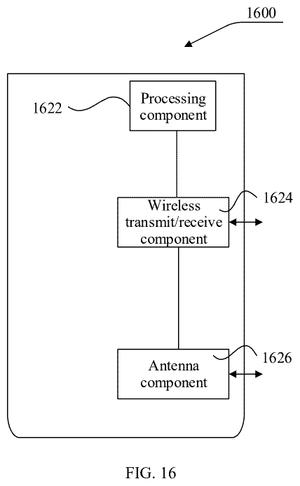

As shown in FIG. 16, FIG. 16 is a schematic structural diagram of an information transmission apparatus 1600 shown according to an exemplary embodiment. The apparatus 1600 may be provided as the unmanned aerial vehicle. Referring to FIG. 16, the apparatus 1600 includes a processing component 1622, a wireless transmit/receive component 1624, an antenna component 1626, and a signal processing part specific to a wireless interface. The processing component 1622 may further include at least one processor.

One processor of the processing component 1622 may be configured to perform any one information transmission method in the side of the unmanned aerial vehicle.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

Optionally, the configuration information is to configure at least one of: a communication standard for a first-type unmanned aerial vehicle to broadcast the identity information, where the first-type unmanned aerial vehicle supports a plurality of communication standards; or a communication standard for a second-type unmanned aerial vehicle to broadcast the identity information, where the second-type unmanned aerial vehicle supports one communication standard.

Optionally, the configuration information is to configure at least one of: the first-type unmanned aerial vehicle to use one of the plurality of communication standards supported by the first-type unmanned aerial vehicle in turn to broadcast the identity information; or the second-type unmanned aerial vehicle to use the communication standard supported by the second-type unmanned aerial vehicle to broadcast the identity information.

Optionally, the configuration information is to configure at least one of: a time point at which the first-type unmanned aerial vehicle broadcasts the identity information with at least one of the plurality of communication standards; a frequency at which the first-type unmanned aerial vehicle broadcasts the identity information with at least one of the plurality of communication standards; a period at which the first-type unmanned aerial vehicle broadcasts the identity information with at least one of the plurality of communication standards; or a power at which the first-type unmanned aerial vehicle broadcasts the identity information with at least one of the plurality of communication standards.

Optionally, the configuration information is to configure a correspondence between a flight parameter value of the first-type unmanned aerial vehicle and the communication standard for the first-type unmanned aerial vehicle to broadcast the identity information.

Optionally, the configuration information is to configure at least one of: a communication standard, when the flight parameter value of the first-type unmanned aerial vehicle is larger than or equal to a preset threshold, for the first-type unmanned aerial vehicle to broadcast the identity information; a communication standard, when the flight parameter value of the first-type unmanned aerial vehicle is less than the preset threshold, for the first-type unmanned aerial vehicle to broadcast the identity information; or the first-type unmanned aerial vehicle to determine, when the flight parameter value of the first-type unmanned aerial vehicle is within a preset threshold range, a communication standard for the first-type unmanned aerial vehicle to broadcast the identity information.

Optionally, the flight parameter value includes at least one of: a flight speed value; or a flight height value.

Optionally, the method further includes: determining a proportion of unmanned aerial vehicles using each of the one or more communication standards; and determining a number of the unmanned aerial vehicles using the communication standard, based on a total number of unmanned aerial vehicles within the coverage range of the base station and the proportion of unmanned aerial vehicles each of the one or more communication standards, determining the number of unmanned aerial vehicles using each of the one or more communication standards; where the sending configuration information to one or more unmanned aerial vehicles within a coverage range of the base station, includes: based on the number of unmanned aerial vehicles using each of the one or more communication standards, sending the configuration information to a corresponding number of unmanned aerial vehicles within the coverage range of the base station respectively, where the configuration information is to configure a target communication standard for each of the one or more unmanned aerial vehicles to use a corresponding target communication standard to broadcast the identity information.

Optionally, the method further includes: determining a first number of unmanned aerial vehicles supporting a specified communication standard within the coverage range of the base station; and determining a first proportion of the first number to the total number; the determining a proportion of unmanned aerial vehicles corresponding to each of the one or more communication standards, includes: determining, in response to determining that the first proportion is larger than or equal to a proportion threshold of unmanned aerial vehicles using the specified communication standard, the proportion of unmanned aerial vehicles using ach of the one or more communication standards.

Optionally, the sending configuration information to one or more unmanned aerial vehicles within a coverage range of the base station, includes: sending the configuration information to each of the one or more unmanned aerial vehicles within the coverage range of the base station with a system message.

Optionally, the sending configuration information to one or more unmanned aerial vehicles within a coverage range of the base station, includes: sending the configuration information to each of the one or more unmanned aerial vehicles in a connected state within the coverage range of the base station with unicast first radio resource control (RRC) signaling.

Optionally, the method further includes: receiving notification information reported by an unmanned aerial vehicle, where the notification information is to at least notify the base station of a communication standard supported by the unmanned aerial vehicle; where the sending configuration information to one or more unmanned aerial vehicles within a coverage range of the base station, includes: sending the configuration information to each of the one or more unmanned aerial vehicles based on the notification information.

Optionally, the notification information is further to notify the base station of capability information for the communication standard supported by the unmanned aerial vehicle.

Optionally, in a case where the notification information is to notify the base station of capability information for the WIFI communication standard supported by the unmanned aerial vehicle, the capability information for the WIFI communication standard includes at least one of: a WIFI version; or a maximum transmitting power.

Optionally, the receiving notification information reported by the unmanned aerial vehicle, includes: receiving the notification information reported by the unmanned aerial vehicle with second RRC signaling.

Optionally, the second RRC signaling includes at least one of: user equipment evolved universal mobile telecommunication system terrestrial radio access network capability (UE-EUTRA-capacity) signaling; user equipment multi-radio technology dual-connectivity capability (UE-MRDC-capacity) signaling; or user equipment new radio capability (UE-NR-capability) signaling.

Optionally, the method further includes: sending query information to the unmanned aerial vehicle, where the query information is to query a communication standard supported by the unmanned aerial vehicle; where the receiving notification information reported by the unmanned aerial vehicle, includes: receiving the notification information reported by the unmanned aerial vehicle based on the query information.

Optionally, the sending query information to the unmanned aerial vehicle, includes: sending the query information to the unmanned aerial vehicle with third RRC signaling.

Optionally, the third RRC signaling includes UE capability enquiry signaling.

Optionally, the query information is to query whether the unmanned aerial vehicle supports a specified communication standard.

Optionally, the configuration information is to configure at least one of: a communication standard for a first-type unmanned aerial vehicle to broadcast the identity information, where the first-type unmanned aerial vehicle supports a plurality of communication standards; or a communication standard for a second-type unmanned aerial vehicle to broadcast the identity information, where the second-type unmanned aerial vehicle supports one communication standard.

Optionally, the configuration information is to configure at least one of: the first-type unmanned aerial vehicle to use one of the plurality of communication standards supported by the first-type unmanned aerial vehicle in turn to broadcast the identity information; or the second-type unmanned aerial vehicle to use the communication standard supported by the second-type unmanned aerial vehicle to broadcast the identity information.

Optionally, the configuration information is to indicate at least one of: a time point at which the first-type unmanned aerial vehicle broadcasts the identity information with at least one of the plurality of communication standards; a frequency at which the first-type unmanned aerial vehicle broadcasts the identity information with at least one of the plurality of communication standards; a period at which the first-type unmanned aerial vehicle broadcasts the identity information with at least one of the plurality of communication standards; or a power at which the first-type unmanned aerial vehicle broadcasts the identity information with at least one of the plurality of communication standards.

Optionally, the configuration information is to configure a correspondence between a flight parameter value of the first-type unmanned aerial vehicle and the communication standard for the first-type unmanned aerial vehicle to broadcast the identity information.

Optionally, the configuration information is to configure at least one of: a communication standard, when the flight parameter value of the first-type unmanned aerial vehicle is larger than or equal to a preset threshold, for the first-type unmanned aerial vehicle to broadcast the identity information; a communication standard, when the flight parameter value of the first-type unmanned aerial vehicle is less than the preset threshold, for the first-type unmanned aerial vehicle to broadcast the identity information; or the first-type unmanned aerial vehicle to determine, when the flight parameter value of the first-type unmanned aerial vehicle is within a preset threshold range, a communication standard for the first-type unmanned aerial vehicle to broadcast the identity information.

Optionally, the flight parameter value includes at least one of: a flight speed value; or a flight height value.

Optionally, the configuration information is to configure the target communication standard.

Optionally, the receiving configuration information sent by a base station, includes: receiving the configuration information sent by the base station with a system message.

Optionally, the receiving configuration information sent by a base station, includes: receiving, in response to determining that the unmanned aerial vehicle is in a connected state, the configuration information sent by the base station with unicast first RRC signaling.

Optionally, the method further includes: reporting notification information to the base station, where the notification information is to at least notify the base station of a communication standard supported by the unmanned aerial vehicle; where the receiving configuration information sent by a base station, includes: receiving the configuration information sent by the base station based on the notification information.

Optionally, the notification information is further to notify the base station of capability information for the communication standard supported by the unmanned aerial vehicle.

Optionally, in a case where the notification information is to notify the base station of capability information for the WIFI communication standard supported by the unmanned aerial vehicle, the capability information for the WIFI communication standard includes at least one of: a WIFI version; or a maximum transmitting power.

Optionally, the reporting notification information to the base station, includes: reporting the notification information to the base station with second RRC signaling.

Optionally, the second RRC signaling includes at least one of: UE-EUTRA-capacity signaling; UE-MRDC-capacity signaling; or UE-NR-capability signaling.

Optionally, the method further includes: receiving query information sent by the base station, where the query information is to query a communication standard supported by the unmanned aerial vehicle; where the reporting notification information to the base station, includes: reporting the notification information to the base station based on the query information.

Optionally, the receiving query information sent by the base station, includes: receiving the query information sent by the base station with third RRC signaling.

Optionally, the third RRC signaling includes UE capability enquiry signaling.

Optionally, the query information is to query whether the unmanned aerial vehicle supports a specified communication standard.

According to a third aspect of embodiments of the present disclosure, an information transmission apparatus is provided. The apparatus is applied to a base station and includes: a sending module, configured to send configuration information to one or more unmanned aerial vehicles within a coverage range of the base station, where the configuration information is to configure one or more communication standards for the one or more unmanned aerial vehicles to broadcast identity information.

According to a fourth aspect of embodiments of the present disclosure, an information transmission apparatus is provided. The apparatus is applied to an unmanned aerial vehicle and includes: a receiving module, configured to receive configuration information sent by a base station, where the unmanned aerial vehicle is within a coverage range of the base station, and the configuration information is to configure a communication standard for the unmanned aerial vehicle to broadcast identity information; a determination module, configured to determine, based on the configuration information, a target communication standard for the unmanned aerial vehicle to broadcast the identity information; and a broadcasting module, configured to broadcast the identity information based on the target communication standard.

According to a seventh aspect of embodiments of the present disclosure, a computer readable storage medium is provided. The computer readable storage medium stores a computer program, and the computer program is configured to perform any one information transmission method in the side of the base station.

According to an eighth aspect of embodiments of the present disclosure, a computer readable storage medium is provided. The computer readable storage medium stores a computer program, and the computer program is configured to perform any one information transmission method in the side of the unmanned aerial vehicle.

1. An information transmission method, performed by a base station and comprising:
sending configuration information to one or more unmanned aerial vehicles within a coverage range of the base station, wherein the configuration information is to configure one or more communication standards for the one or more unmanned aerial vehicles to broadcast identity information.

2. The method of claim 1, wherein the configuration information is to configure at least one of:
a communication standard for a first-type unmanned aerial vehicle to broadcast the identity information, wherein the first-type unmanned aerial vehicle supports a plurality of communication standards; or
a communication standard for a second-type unmanned aerial vehicle to broadcast the identity information, wherein the second-type unmanned aerial vehicle supports one communication standard.

3. The method of claim 2, wherein the configuration information is to configure at least one of:
the first-type unmanned aerial vehicle to use one of the plurality of communication standards supported by the first-type unmanned aerial vehicle in turn to broadcast the identity information;
the second-type unmanned aerial vehicle to use the communication standard supported by the second-type unmanned aerial vehicle to broadcast the identity information;
at least one of a time point, a frequency, a period, or a power at which the first-type unmanned aerial vehicle broadcasts the identity information with at least one of the plurality of communication standards; or
a correspondence between a flight parameter value of the first-type unmanned aerial vehicle and the communication standard for the first-type unmanned aerial vehicle to broadcast the identity information, wherein the flight parameter value comprises at least one of a flight speed value or a flight height value.

4-5. (canceled)

6. The method of claim 3, wherein the correspondence comprises at least one of:
a communication standard, when the flight parameter value of the first-type unmanned aerial vehicle is larger than or equal to a preset threshold, for the first-type unmanned aerial vehicle to broadcast the identity information;
a communication standard, when the flight parameter value of the first-type unmanned aerial vehicle is less than the preset threshold, for the first-type unmanned aerial vehicle to broadcast the identity information; or
the first-type unmanned aerial vehicle to determine, when the flight parameter value of the first-type unmanned aerial vehicle is within a preset threshold range, a communication standard for the first-type unmanned aerial vehicle to broadcast the identity information.

7. (canceled)

8. The method of claim 1, wherein the sending configuration information to one or more unmanned aerial vehicles within a coverage range of the base station, comprises:
determining a first number of unmanned aerial vehicles supporting a specified communication standard within the coverage range of the base station; and
determining a first proportion of the first number to the total number;
determining, in response to determining that the first proportion is larger than or equal to a proportion threshold of unmanned aerial vehicles using the specified communication standard, a proportion of unmanned aerial vehicles corresponding to each of the one or more communication standards; and
based on a total number of unmanned aerial vehicles within the coverage range of the base station and the proportion of unmanned aerial vehicles corresponding to each of the one or more communication standards, determining a number of unmanned aerial vehicles corresponding to each of the one or more communication standards;
based on the number of unmanned aerial vehicles corresponding to each of the one or more communication standards, sending the configuration information to a corresponding number of unmanned aerial vehicles within the coverage range of the base station respectively, wherein the configuration information is to configure each of the one or more unmanned aerial vehicles to use a corresponding target communication standard to broadcast the identity information.

9. (canceled)

10. The method of claim 1, wherein the sending configuration information to one or more unmanned aerial vehicles within a coverage range of the base station, comprises:
sending the configuration information to each of the one or more unmanned aerial vehicles within the coverage range of the base station with a system message; or
sending the configuration information to each of the one or more unmanned aerial vehicles in a connected state within the coverage range of the base station with unicast first radio resource control (RRC) signaling.

11. (canceled)

12. The method of claim 1, wherein the method further comprises:
receiving notification information reported by an unmanned aerial vehicle, where the notification information is to at least notify the base station of a communication standard supported by the unmanned aerial vehicle;
wherein the sending configuration information to one or more unmanned aerial vehicles within a coverage range of the base station, comprises:
sending the configuration information to each of the one or more unmanned aerial vehicles based on the notification information.

13. The method of claim 12, wherein the notification information is further to notify the base station of capability information for the communication standard supported by the unmanned aerial vehicle;
wherein in a case where the notification information is to notify the base station of capability information for wireless fidelity (WIFI) communication standard supported by the unmanned aerial vehicle, the capability information for the WIFI communication standard comprises at least one of:
a WIFI version; or
a maximum transmitting power.

14. (canceled)

15. The method of claim 12, wherein the receiving notification information reported by an unmanned aerial vehicle, comprises:
receiving the notification information reported by the unmanned aerial vehicle with second RRC signaling;
wherein the second RRC signaling comprises at least one of:
user equipment evolved universal mobile telecommunication system terrestrial radio access network capability (UE-EUTRA-capacity) signaling;
user equipment multi-radio technology dual-connectivity capability (UE-MRDC-capacity) signaling; or
user equipment new radio capability (UE-NR-capability) signaling.

16. (canceled)

17. The method of claim 12, wherein the method further comprises:
sending query information to the unmanned aerial vehicle, wherein the query information is to query a communication standard supported by the unmanned aerial vehicle, or is to query whether the unmanned aerial vehicle supports a specified communication standard;
wherein the receiving notification information reported by an unmanned aerial vehicle, comprises:
receiving the notification information reported by the unmanned aerial vehicle based on the query information;
wherein the sending query information to the unmanned aerial vehicle, comprises:
sending the query information to the unmanned aerial vehicle with third RRC signaling;
wherein the third RRC signaling comprises UE capability enquiry signaling.

18-20. (canceled)

21. An information transmission method, performed by an unmanned aerial vehicle and comprising:
receiving configuration information sent by a base station, wherein the unmanned aerial vehicle is within a coverage range of the base station, and the configuration information is to configure a communication standard for the unmanned aerial vehicle to broadcast identity information;
determining, based on the configuration information, a target communication standard for the unmanned aerial vehicle to broadcast the identity information; and
broadcasting the identity information based on the target communication standard.

22-27. (canceled)

28. The method of claim 21, wherein the configuration information is to configure the target communication standard.

29. The method of claim 21, wherein the receiving configuration information sent by a base station, comprises:
receiving the configuration information sent by the base station with a system message; or
receiving, in response to determining that the unmanned aerial vehicle is in a connected state, the configuration information sent by the base station with unicast first radio resource control (RRC) signaling.

30. (canceled)

31. The method of claim 21, wherein the method further comprises:
reporting notification information to the base station, wherein the notification information is to at least notify the base station of a communication standard supported by the unmanned aerial vehicle;
wherein the receiving configuration information sent by a base station, comprises:
receiving the configuration information sent by the base station based on the notification information.

32-33. (canceled)

34. The method of claim 31, wherein the reporting notification information to the base station, comprises:
reporting the notification information to the base station with second RRC signaling;
wherein the second RRC signaling comprises at least one of:
user equipment evolved universal mobile telecommunication system terrestrial radio access network capability (UE-EUTRA-capacity) signaling;
user equipment multi-radio technology dual-connectivity capability (UE-MRDC-capacity) signaling; or
user equipment new radio capability (UE-NR-capability) signaling.

35. (canceled)

36. The method of claim 31, wherein the method further comprises:
receiving query information sent by the base station, wherein the query information is to query a communication standard supported by the unmanned aerial vehicle, or is to query whether the unmanned aerial vehicle supports a specified communication standard;
wherein the reporting notification information to the base station, comprises:
reporting the notification information to the base station based on the query information;
wherein the receiving query information sent by the base station, comprises:
receiving the query information sent by the base station with third RRC signaling;
wherein the third RRC signaling comprises UE capability enquiry signaling.

37-41. (canceled)

42. A non-transitory computer readable storage medium, storing a computer program, wherein a computer executes the computer program to implement the information transmission method of claim 1.

43. A non-transitory computer readable storage medium, storing a computer program, wherein a computer executes the computer program to implement the information transmission method of claim 21.

44. An information transmission apparatus, comprising:
a processor; and
a memory configured to store instructions executable by the processor;
wherein the processor executes the instructions to:
send configuration information to one or more unmanned aerial vehicles within a coverage range of the base station, wherein the configuration information is to configure one or more communication standards for the one or more unmanned aerial vehicles to broadcast identity information.

45. An information transmission apparatus, comprising:
a processor; and
a memory configured to store instructions executable by the processor;
wherein the processor executes the instructions to implement the information transmission method of claim 21.
